(19) United States
(12) Patent Application Publication
(10) Pub. No.: US 2011/0298749 A1
(43) Pub. Date: Dec. 8, 2011

(54) MUTUAL CAPACITANCE TOUCH PANEL

(75) Inventor: Jane HSU, Guishan Township (TW)

(73) Assignee: DERLEAD INVESTMENT LTD., Taipei (TW)

(21) Appl. No.: 13/118,312

(22) Filed: May 27, 2011

(30) Foreign Application Priority Data
Jun. 3, 2010 (TW) 099210508

(51) Int. Cl. G06F 3/044

(52) U.S. Cl. 345/174

(57) ABSTRACT

A mutual capacitance touch panel has an at-least-95% overlap rate of area between each upper sensing area of an upper sensing unit mounted thereon and a corresponding lower sensing area of a lower sensing unit mounted thereon. Given such layout, the mutual capacitance touch panel has an error between detected touch points and actually touched points controlled within a smaller range. Accordingly, the mutual capacitance touch panel has enhanced touch accuracy.

### BACKGROUND OF THE INVENTION

1. Field of the Invention

The present invention relates to a touch panel, and more particularly to a projected mutual capacitance touch panel having an increased overlap area between an upper sensing unit and a lower sensing unit formed on the mutual capacitance touch panel to enhance a touch accuracy of the touch panel.

2. Description of the Related Art

Touch panels can be classified into various types based on the technologies behind them. Owing to the multi-touch function, projected mutual capacitance touch panels have gradually been eye-catching in the market since the announcement of multi-touch electronic products, such as iPhone released by Apple Inc. The projected capacitive touch panels can be further classified into a self capacitance type and a mutual capacitance type. In contrast to a self capacitance touch panel usually having a single layer of conductive electrode, with reference to FIGS. 5 and 6, a conventional mutual capacitance touch panel has an upper layer electrode 61, a lower layer electrode 71 and an insulation adhesive layer 80. The upper layer electrode 61 is mounted on a bottom surface of an upper substrate 60 and has multiple upper sensing areas 611. The lower layer electrode 71 is formed on a top surface of a lower substrate 70 and has multiple lower sensing areas 711. The insulating adhesive layer 80 is mounted between the bottom surface of the upper substrate 60 and the top surface of the lower substrate 70 to isolate the upper sensing areas 611 from the lower sensing areas 711. Thus, capacitance can be generated between the upper sensing areas 611 and the lower sensing areas 711 for detection of touched points.

However, the upper sensing areas 611 and the lower sensing areas 711 of the conventional mutual capacitance touch panel differ in shape and size, and the upper sensing areas 611 and the lower sensing areas 711 only partially overlap each other. Accordingly, the problem that the detected touch points differ from the points actually touched by a user causes unsatisfactory touch accuracy of the conventional mutual capacitance touch panel.

### SUMMARY OF THE INVENTION

An objective of the present invention is to provide a mutual capacitance touch panel having an increased overlap area between an upper sensing unit and a lower sensing unit formed on the mutual capacitance touch panel to enhance a touch accuracy of the touch panel.

To achieve the foregoing objective, the mutual capacitance touch panel has a substrate, a lower sensing unit and an upper sensing unit.

The lower sensing unit is mounted on a bottom surface of the substrate and has multiple lower conductive layers parallelly aligning in a first direction. Each lower conductive layer has multiple lower sensing areas serially connected.

The upper sensing unit is mounted on a top surface of the substrate and has multiple upper conductive layers parallelly aligning in a second direction. Each upper conductive layer has multiple upper sensing areas serially connected. The upper sensing areas respectively correspond to the lower sensing areas. An overlap rate of area between each upper sensing area and a corresponding lower sensing area is at least 95%.

Alternatively, the mutual capacitance touch panel has a lower substrate, a lower sensing unit, an insulating adhesive layer, an upper substrate and an upper sensing unit.

The lower sensing unit is mounted on a top surface of the lower substrate and has multiple lower conductive layers parallelly aligning in a first direction. Each lower conductive layer has multiple lower sensing areas serially connected.

The insulating adhesive layer is mounted on the top surface of the lower substrate.

The upper substrate is mounted on a top surface of the insulating adhesive layer.

The upper sensing unit is mounted on a bottom surface of the upper substrate and has multiple upper conductive layers parallelly aligning in a second direction. Each upper conductive layer has multiple upper sensing areas serially connected. The upper sensing areas respectively correspond to the lower sensing areas. An overlap rate of area between each upper sensing area and a corresponding lower sensing area is at least 95%.

As the overlap rate of area between each upper sensing area and a corresponding lower sensing area is at least 95%, the error between a detected touch point and an actual touch point can be controlled within a smaller range. Accordingly, the mutual capacitance touch panel of the present invention has enhanced touch accuracy.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a first embodiment of a mutual capacitance touch panel in accordance with the present invention;

FIG. 2 is a bottom view of the mutual capacitance touch panel in FIG. 1;

FIG. 3 another top view of the mutual capacitance touch panel in FIG. 1;

FIG. 4 is an exploded perspective view of a second embodiment of a mutual capacitance touch panel in accordance with the present invention;

FIG. 5 is an exploded perspective view of a conventional mutual capacitance touch panel; and

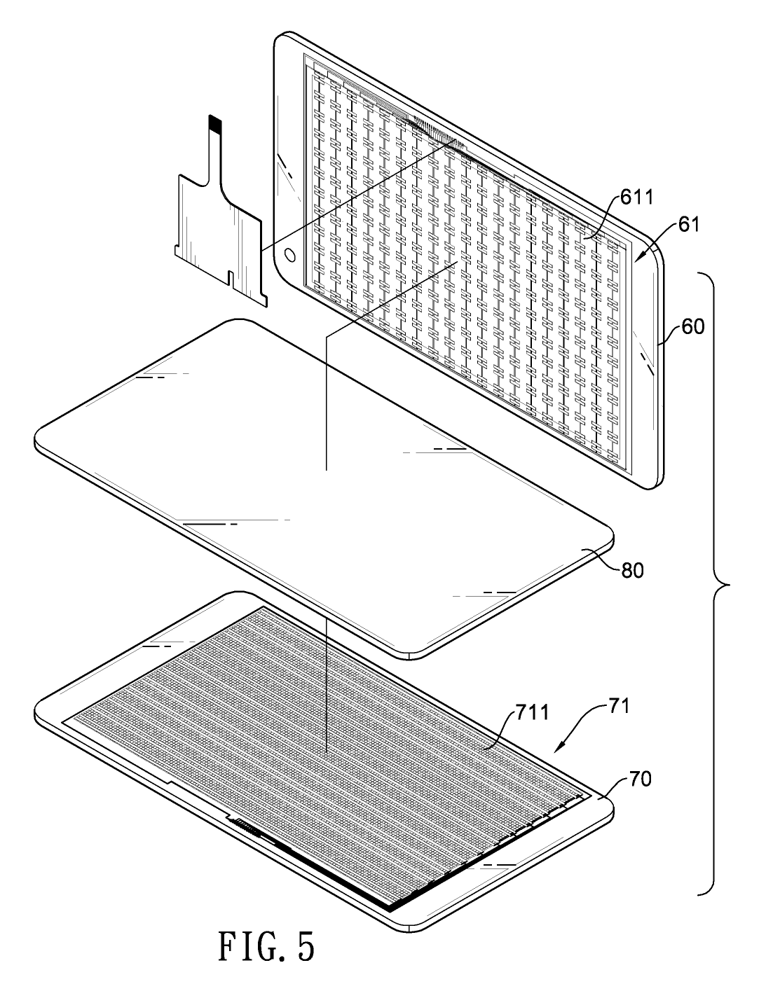

FIG. 6 is an enlarged top view of the conventional mutual capacitance touch panel in FIG. 5.

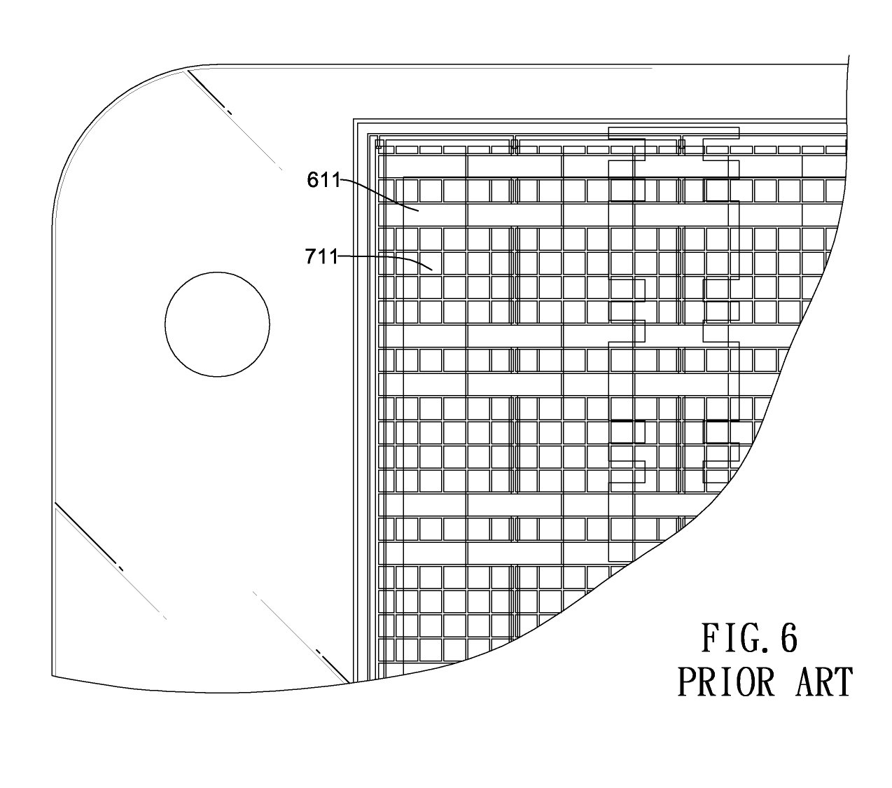

### DETAILED DESCRIPTION OF THE INVENTION

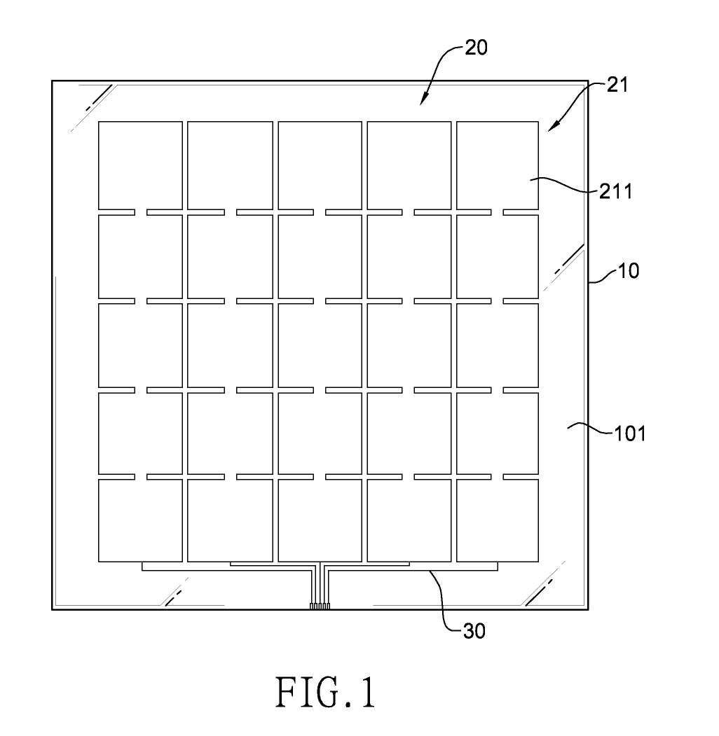

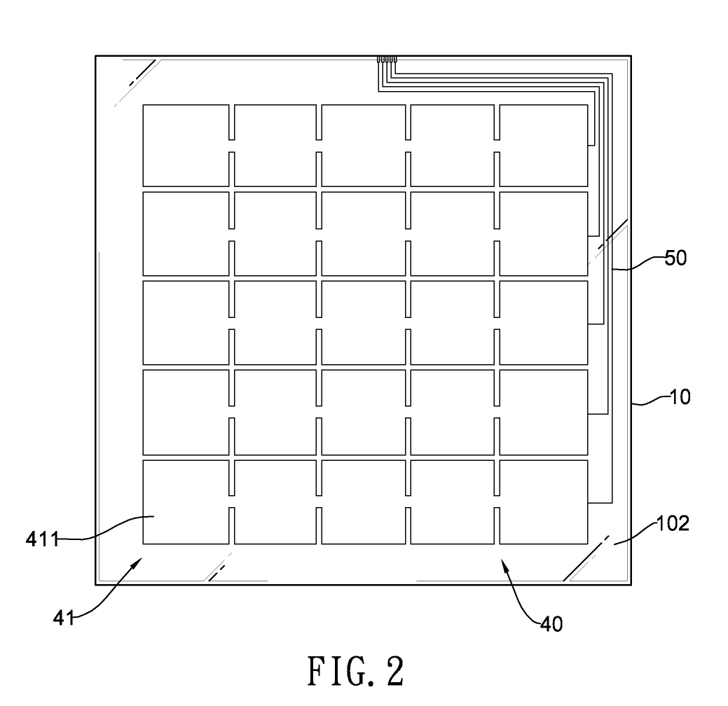

With reference to FIGS. 1 and 2, a first embodiment of a mutual capacitance touch panel in accordance with the present invention has a substrate 10, a lower sensing unit 20, multiple lower wires 30, an upper sensing unit 40 and multiple upper wires 50.

The lower sensing unit 20 is mounted on a bottom surface 101 of the substrate 10 and has multiple lower conductive layers 21 parallelly aligning in a first direction. Each lower conductive layer 21 has multiple lower sensing areas 211 serially connected. In the present embodiment, the lower sensing areas 211 are rectangular.

The lower wires 30 correspond to the lower conductive layers 21 in number. One end of each lower wire 30 is connected to the lower sensing area 211 located at one end of one of the lower conductive layers 21.

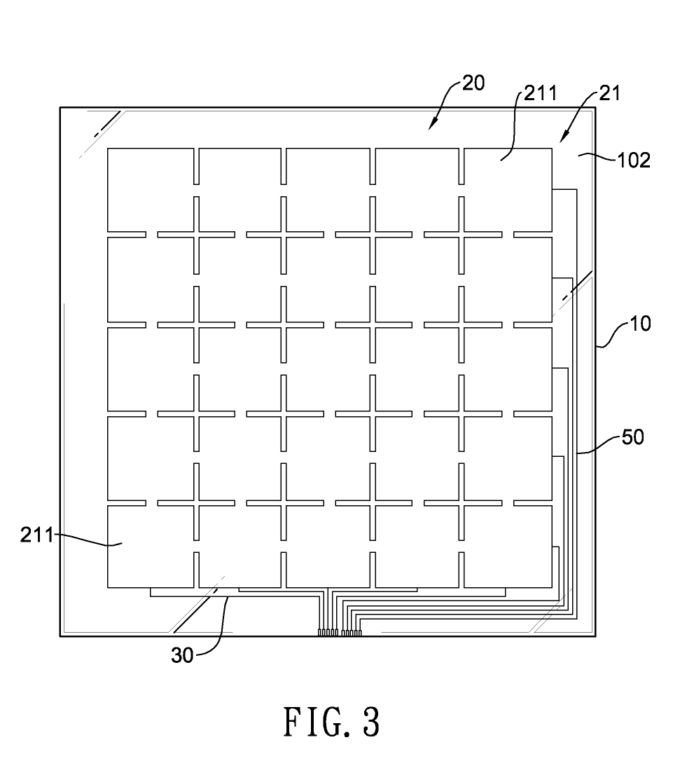

The upper sensing unit 40 is mounted on a top surface 102 of the substrate 10 and has multiple upper conductive layers 41 parallelly aligning in a second direction. In the present embodiment, the second direction is perpendicular to the first direction. Each upper conductive layer 41 has multiple upper sensing areas 411 serially connected. The upper sensing areas 411 respectively correspond to the lower sensing areas 211. An overlap rate of area between each upper sensing area 411 and a corresponding lower sensing area 211 is at least 95%. With reference to FIG. 3, the upper sensing areas 411 are identical to the lower sensing areas 211 in shape, and the upper sensing areas 411 respectively and completely overlap the lower sensing areas 211.

The upper wires 50 correspond to the upper conductive layer 41 in number. One end of each upper wire 50 is connected to the upper sensing area 411 located at one end of one of the upper conductive layers 41.

The lower conductive layers 21 and the upper conductive layers 41 are composed of indium tin oxide (ITO). The lower conductive layers 21 and the upper conductive layer 41 can be generated by mounting ITO on the bottom surface 101 and the top surface 102 of the substrate and etching the ITO to obtain gaps between the upper conductive layers 41, the lower conductive layers 21, the upper sensing areas 411 and the lower sensing areas 211.

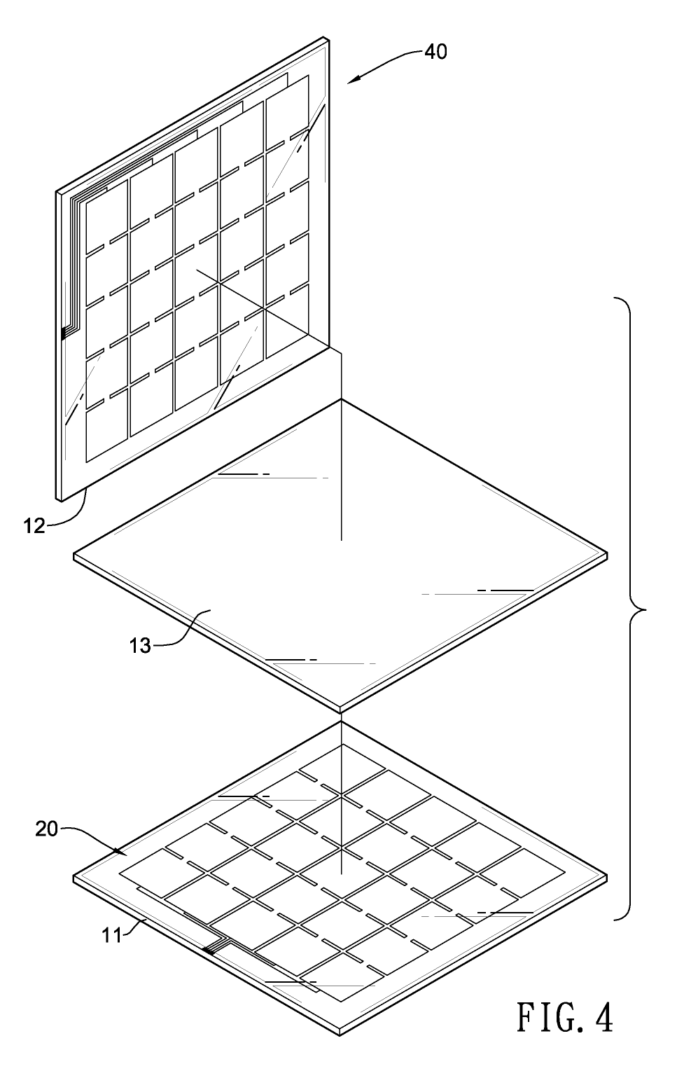

With reference to FIG. 4, a second embodiment of a mutual capacitance touch panel in accordance with the present invention is shown and differs from the first embodiment in having a lower substrate 11, an insulating adhesive layer 13 and an upper substrate 12. The lower sensing unit 20 mentioned in the first embodiment is mounted on a top surface of the lower substrate 11. The upper sensing unit 40 mentioned in the first embodiment is mounted on a bottom surface of the upper substrate 12. The insulating adhesive layer 13 is mounted between the top surface of the lower substrate 11 and the bottom surface of the upper substrate 12.

In contrast to conventional mutual capacitance touch panels, the overlap rate of area between each upper sensing area 411 and a corresponding lower sensing area 211 in the present invention is at least 95%. The error between a detected touch point and an actual touch point can be controlled within a smaller range. If the upper sensing areas 411 and the lower sensing areas 211 completely overlap each other, no error exists between the detected touch point and the actual touch point. Accordingly, the mutual capacitance touch panel of the present invention has enhanced touch accuracy.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A mutual capacitance touch panel comprising:
a substrate;
a lower sensing unit mounted on a bottom surface of the substrate and having multiple lower conductive layers parallelly aligning in a first direction, wherein each lower conductive layer has multiple lower sensing areas serially connected; and
an upper sensing unit mounted on a top surface of the substrate and having multiple upper conductive layers parallelly aligning in a second direction, wherein each upper conductive layer has multiple upper sensing areas serially connected, the upper sensing areas respectively correspond to the lower sensing areas, and an overlap rate of area between each upper sensing area and a corresponding lower sensing area is at least ninety five percent.

2. The mutual capacitance touch panel as claimed in claim 1, wherein each upper sensing area completely overlaps a corresponding lower sensing area.

3. The mutual capacitance touch panel as claimed in claim 1, wherein the first direction is perpendicular to the second direction.

4. The mutual capacitance touch panel as claimed in claim 2, wherein the first direction is perpendicular to the second direction.

5. The mutual capacitance touch panel as claimed in claim 1, wherein the upper sensing areas and the lower sensing areas are rectangular.

6. The mutual capacitance touch panel as claimed in claim 2, wherein the upper sensing areas and the lower sensing areas are rectangular.

7. The mutual capacitance touch panel as claimed in claim 3, wherein the upper sensing areas and the lower sensing areas are rectangular.

8. The mutual capacitance touch panel as claimed in claim 4, wherein the upper sensing areas and the lower sensing areas are rectangular.

9. A mutual capacitance touch panel comprising:
a lower substrate;
a lower sensing unit mounted on a top surface of the lower substrate and having multiple lower conductive layers parallelly aligning in a first direction, wherein each lower conductive layer has multiple lower sensing areas serially connected;
an insulating adhesive layer mounted on the top surface of the lower substrate;
an upper substrate mounted on a top surface of the insulating adhesive layer;
an upper sensing unit mounted on a bottom surface of the upper substrate and having multiple upper conductive layers parallelly aligning in a second direction, wherein each upper conductive layer has multiple upper sensing areas serially connected, the upper sensing areas respectively correspond to the lower sensing areas, and an overlap rate of area between each upper sensing area and a corresponding lower sensing area is at least ninety five percent.

10. The mutual capacitance touch panel as claimed in claim 9, wherein each upper sensing area completely overlaps a corresponding lower sensing area.

11. The mutual capacitance touch panel as claimed in claim 9, wherein the first direction is perpendicular to the second direction.

12. The mutual capacitance touch panel as claimed in claim 10, wherein the first direction is perpendicular to the second direction.

13. The mutual capacitance touch panel as claimed in claim 9, wherein the upper sensing areas and the lower sensing areas are rectangular.

14. The mutual capacitance touch panel as claimed in claim 10, wherein the upper sensing areas and the lower sensing areas are rectangular.

15. The mutual capacitance touch panel as claimed in claim 11, wherein the upper sensing areas and the lower sensing areas are rectangular.

16. The mutual capacitance touch panel as claimed in claim 12, wherein the upper sensing areas and the lower sensing areas are rectangular.
